(19) United States
(12) Patent Application Publication
(10) Pub. No.: US 2021/0216917 A1
(43) Pub. Date: Jul. 15, 2021

(54) VEHICLE AND USER MERGING ASSIST SYSTEM AND VEHICLE RIDE-SHARING ASSIST SYSTEM

(71) Applicant: HONDA MOTOR CO., LTD., Minato-ku, Tokyo (JP)

(72) Inventor: Kenichi KOBAYASHI, Saitama (JP)

(21) Appl. No.: 15/734,277

(22) PCT Filed: Jun. 4, 2019
(86) PCT No.: PCT/JP2019/022112

§ 371 Date: Dec. 2, 2020

(30) Foreign Application Priority Data
Jun. 8, 2018 (JP) 2018-109981

(51) Int. Cl. G06Q 10/02; G06Q 10/06; G06Q 50/30

(52) U.S. Cl. CPC G06Q 10/02; G06Q 50/30; G06Q 10/06315; G06Q 10/06312

(57) ABSTRACT

To eliminate a waiting time and thus to assist in efficient merging when a vehicle and a user to board the vehicle merge with each other, a server (5) of a vehicle and user merging assist system includes a merging schedule setting unit (22), a notification unit (21), and a merging route setting unit (25). The merging schedule setting unit (22) sets a merging schedule in response to an application of the user. The merging schedule includes a merging point (P) and a merging time of a ride-sharing vehicle (10) and the user, a vehicle route (Rv) of the ride-sharing vehicle (10) to the merging point (P), and a user route (Ry) of the user to the merging point (P). The notification unit (21) notifies a vehicle terminal (3) and a user terminal (2) of information about the merging schedule. The merging route setting unit (25) estimates a scheduled arrival time at the merging point (P) of each of the ride-sharing vehicle (10) and the user based on an estimation result of a position estimating unit (24, 23) that estimates a position of the ride-sharing vehicle (10) and a position of the user, and to set a merging route (Rm) along the vehicle route (Rv) or the user route (Ry) of one of the ride-sharing vehicle (10) and the user whose scheduled arrival time is the later of the two. The notification unit (21) notifies the vehicle terminal (3) and the user terminal (2) of the merging route (Rm).

### TECHNICAL FIELD

The present disclosure relates to a vehicle and user merging assist system for assisting in merging of a vehicle driven by a driver and a user moving to board the vehicle, and to a vehicle ride-sharing assist system including the vehicle and user merging assist system.

### BACKGROUND ART

A known method for determining a termination of a trip provided by a transport service is implemented by one or more processors of a transport arrangement service. The above method includes a step of collecting passive information (for example, positional information from GPS) from a computing device of a driver, a step of receiving input from the driver via the computing device, a step of signaling the termination, and a step of determining the termination based on the input from the driver and the passive information (see Patent Document 1).

Also, regarding a vehicle sharing assist system that introduces a ride-sharing method in which plural members utilize the same vehicle at the same time, Patent Document 2 discloses a technique that optimizes a setting method of a pickup point for improving convenience. The pickup point is a point where a shared vehicle, which one member (the former boarding member) has boarded, picks up another member (the latter boarding member) on the way to the destination of the boarded one member. In the above technique, candidates of the pickup point are selected, and then priority order is set to the candidates based on the ease to arrive and wait at the pickup point. The candidates with priority orders are presented to the latter boarding member, and the pickup point is determined according to the selection by the latter boarding member.

### PRIOR ART DOCUMENT(S)

### Patent Document(s)

Patent Document 1: US2017/0358147A1

Patent Document 2: JP2003-006294A

### SUMMARY OF THE INVENTION

### Task to be Accomplished by the Invention

However, in a conventional vehicle ride-sharing assist system, the pickup point is set as a point. Accordingly, when many ride-sharing services are being provided, the pickup point is crowded with the ride-sharing vehicles. Consequently, it takes time for a ride-sharing person to merge with the ride-sharing vehicle even if both the ride-sharing vehicle and the ride-sharing person arrive at the pickup point, which may prevent an efficient operation of the system.

Further, there is a case where the ride-sharing vehicle/ride-sharing person to provide/utilize the ride-sharing service cannot arrive at a set pickup point at a set time due to an external factor such as a traffic condition or a human factor such as a delay in departure. If the pickup point is set as a point in such a case, one of the ride-sharing vehicle and the ride-sharing person needs to wait for the arrival of the other of the ride-sharing vehicle and the ride-sharing person, except for a rare case where the ride-sharing vehicle and the ride-sharing person arrive at the same time. Accordingly, the required time for arriving at the destination is extended, which means that the system cannot utilize the ride-sharing vehicle efficiently. Also, the waiting time imposes a mental burden on the users of the service (the driver and the ride-sharing person), which may decrease a utilization rate and a satisfaction degree of the ride-sharing service.

In view of such a background, an object of the present invention is to provide a vehicle and user merging assist system that can eliminate a waiting time and thus assist in efficient merging when a vehicle and a user to board the vehicle merge with each other, and further to provide a vehicle ride-sharing assist system that includes the vehicle and user merging assist system and can efficiently provide a ride-sharing service.

### Means for Accomplishing the Task

To achieve such an object, one embodiment of the present invention provides a vehicle and user merging assist system (1) for assisting in merging of a vehicle (10) and a user, including: a vehicle terminal (3) configured to be mounted on the vehicle; a user terminal (2) configured to be carried by the user; and a server (5) configured to communicate with the vehicle terminal and the user terminal, wherein the server includes: a merging schedule setting unit (22) configured to set a merging schedule based on a departure point of each of the vehicle (10) and the user in response to an application of the user transmitted from the user terminal, the merging schedule including a merging point (P) and a merging time of the vehicle (10) and the user, a vehicle route (Rv) of the vehicle (10) to the merging point (P), and a user route (Ry) of the user to the merging point (P); a notification unit (21) configured to notify the vehicle terminal and the user terminal of information about the merging schedule; a position estimating unit (23, 24) configured to estimate a position of the vehicle and a position of the user; and a merging route setting unit (25) configured to estimate a scheduled arrival time at the merging point (P) of each of the vehicle and the user based on an estimation result of the position estimating unit and to set a merging route (Rm) where the vehicle and the user should merge with each other along the vehicle route (Rv) or the user route (Ry) of one of the vehicle and the user, the scheduled arrival time of the one of the vehicle and the user being later than the scheduled arrival time of another of the vehicle and the user, and the notification unit (21) is configured to notify the vehicle terminal and the user terminal of the merging route.

According to this arrangement, in a case where the vehicle and the user cannot arrive at the merging point at the same time, the merging route setting unit sets not a point but a merging route with a certain length as a place where the vehicle and the user should merge with each other, and the merging route is notified to the vehicle terminal and the user terminal. Accordingly, a waiting time can be reduced when the vehicle and the user merge with each other. Further, the merging route setting unit sets the merging route along the vehicle route or the user route of one of the vehicle and the user, and the scheduled arrival time of the one of the vehicle and the user is later than the scheduled arrival time of another of the vehicle and the user. Accordingly, the time required for merging can be shortened and thus merging can be efficient. Furthermore, the merging route with a certain length is set as a place where the vehicle and the user should merge with each other. Accordingly, the merging vehicles do not concentrate at one point and thus congestion of the merging vehicles is prevented, which also assists in efficient merging.

In the above arrangement, preferably, the merging schedule setting unit (22) is configured to set the user route (Ry) on a side of a lane of a road at least in a vicinity of the merging point (P), the lane corresponding to a traveling direction of the vehicle (10).

According to this arrangement, the vehicle and the user moving in the vicinity of the merging point can easily find each other. Also, after the vehicle and the user find each other, the user can board the vehicle without crossing the road, so that merging can be efficient.

In the above arrangement, preferably, the merging route setting unit (25) is configured to start estimating the scheduled arrival time after receiving a vehicle departure signal indicating that the vehicle (10) will depart from the departure point and a user departure signal indicating that the user will depart from the departure point.

According to this arrangement, it is not necessary to estimate the scheduled arrival time before the departure of the vehicle and the user, so that the processing load of the merging route setting unit can be reduced.

In the above arrangement, preferably, when the merging route setting unit (25) detects that the vehicle (10) and the user have approached each other within a prescribed distance based on the estimation result of the position estimating unit (23, 24), the notification unit (21) notifies the vehicle terminal (3) and the user terminal (2) that the vehicle and the user have approached each other.

According to this arrangement, the vehicle and the user can easily find each other.

In the above arrangement, preferably, the merging schedule setting unit (22) is configured to set the merging point (P) on a road where the vehicle can stop and a sidewalk is provided.

According to this arrangement, the merging point is set on a road suitable for merging, so that merging can be efficient.

In the above arrangement, preferably, the merging route setting unit (25) is configured to set the merging route (Rm) on a road where the vehicle can stop and a sidewalk is provided.

According to this arrangement, the merging route is set on a road which is suitable for merging and where the vehicle or the user can easily move, so that merging can be efficient.

In the above arrangement, preferably, the vehicle and user merging assist system further includes a display device (18) configured to be mounted on the vehicle (10) and to display the position of the user on a windshield based on the estimation result of the position estimating unit (23, 24).

According to this arrangement, the driver of the vehicle can easily find the user.

In the above arrangement, preferably, the user terminal includes a vehicle identifying unit configured to identify the vehicle based on the estimation result of the position estimating unit.

According to this arrangement, the user can easily find the vehicle.

Also, another embodiment of the present invention provides a vehicle ride-sharing assist system (1) including the vehicle and user merging assist system (1) with the above arrangements and configured to provide plural users with ride-sharing of a ride-sharing vehicle (10), wherein the server (5) includes an operation schedule setting unit (22) configured to set an operation schedule based on a departure point and a departure time of each of the ride-sharing vehicle (10) and the users in response to a ride-sharing application of each user transmitted from the user terminal (2), the operation schedule including the merging schedule and a ride-sharing schedule that includes a ride-sharing route (Rs) from the merging point (P) to a destination, and in a case where it is determined that the user has boarded the ride-sharing vehicle (10) at a place different from the merging point (P) based on the estimation result of the position estimating unit (23, 24), the operation schedule setting unit (22) changes the ride-sharing route and the notification unit (21) notifies the vehicle terminal (3) of the changed ride-sharing route.

According to this arrangement, in a case where the vehicle and the user merge with each other at a place different from the merging point on the merging route, the ride-sharing route is changed and notified to the vehicle terminal, so that the ride-sharing route can be shortened. Accordingly, ride-sharing and operation of the vehicle ride-sharing assist system can be efficient.

### Effect of the Invention

Thus, according to the present invention, it is possible to provide a vehicle and user merging assist system that can eliminate a waiting time and thus assist in efficient merging when a vehicle and a user to board the vehicle merge with each other, and further to provide a vehicle ride-sharing assist system that includes the vehicle and user merging assist system and can efficiently provide a ride-sharing service.

### BRIEF DESCRIPTION OF THE DRAWING(S)

FIG. 1 is a block diagram of a vehicle ride-sharing assist system according to an embodiment;

FIG. 2 is a sequence diagram showing a flow of a ride-sharing service according to the embodiment;

FIG. 3 is a flowchart of ride-sharing service processing executed by a host server;

FIG. 4 is a schematic diagram of an operation schedule set in step ST22 of FIG. 3;

FIG. 5 is a schematic diagram of an operation schedule set in step ST29 of FIG. 3;

FIG. 6 is a schematic diagram of an operation schedule set in step ST30 of FIG. 3;

FIG. 7 is a diagram showing a user identifying screen displayed on a ride-sharing vehicle;

FIG. 8 is a diagram showing a ride-sharing vehicle identifying screen displayed on a user terminal; and

FIG. 9 is a schematic diagram of a changed ride-sharing route set in step ST35 of FIG. 3.

### MODE(S) FOR CARRYING OUT THE INVENTION

In the following, with reference to the drawings, the embodiment of the present invention will be described in detail. In the present embodiment, a vehicle and user merging assist system for assisting in merging of a vehicle and a user is applied to a vehicle ride-sharing assist system 1. The vehicle ride-sharing assist system 1 according to the present embodiment is administered by an administrator who belongs to a specific group (a company, a government office, a sports club, a nursing home, a shopping center, or the like), and provides a ride-sharing service of the vehicle to the members who belong to the specific group. The ride-sharing service of the vehicle is provided every prescribed time (hereinafter referred to as “term”). Especially, the vehicle ride-sharing assist system 1 provides a ride-sharing service of an automobile when the members of the specific group commute in the morning or evening or go to a facility.

The ride-sharing service described herein includes steps of: receiving a ride-sharing application including desired ride-sharing conditions (for example, a departure point, a destination, a departure time, and an arrival time) from each member; determining an optimal combination of the members who perform ride-sharing (a combination of one driver and at least one ride-sharing person), an optimal ride-sharing vehicle 10, and an optimal operation schedule for the ride-sharing vehicle 10 (for example, a driver, an operation route (commuting route) that can minimize traffic congestion, a scheduled departure time and a scheduled merging time, and an operating time such as a scheduled arrival time at a destination) based on the received desired ride-sharing conditions; and notifying each member of these determined matters. The operation route includes: routes to a merging point P (namely, routes before merging) of the ride-sharing person and the ride-sharing vehicle 10 (a user route Ry and a vehicle route Rv which will be described later); and a ride-sharing route Rs from the merging point P to the destination (namely, a route after merging) of the ride-sharing vehicle 10.

The specific group that utilizes the vehicle ride-sharing assist system 1 according to the present embodiment owns plural shared vehicles in order to cause the members thereof to use the shared vehicles. For the ride-sharing, the vehicle ride-sharing assist system 1 uses the plural shared vehicles and the members' private vehicles which the members have agreed to use for the ride-sharing (hereinafter referred to as “provided vehicles”). All the members, the shared vehicles, and the provided vehicles are registered in the vehicle ride-sharing assist system 1. In the vehicle ride-sharing assist system 1, user identification numbers are set for all the members, and vehicle identification numbers are set for all the shared vehicles and all the provided vehicles.

In the following, for simplification, it is assumed that a specific member is set as the driver of the ride-sharing vehicle 10 and a specific shared vehicle or a specific provided vehicle is set as the ride-sharing vehicle 10 that the driver drives for the ride-sharing. Accordingly, the member other than the driver is set as the ride-sharing person. In the following, the member set as the ride-sharing person will be referred to as “user” so as to distinguish this member from the driver. However, the member including the driver will be sometimes referred to as “user”.

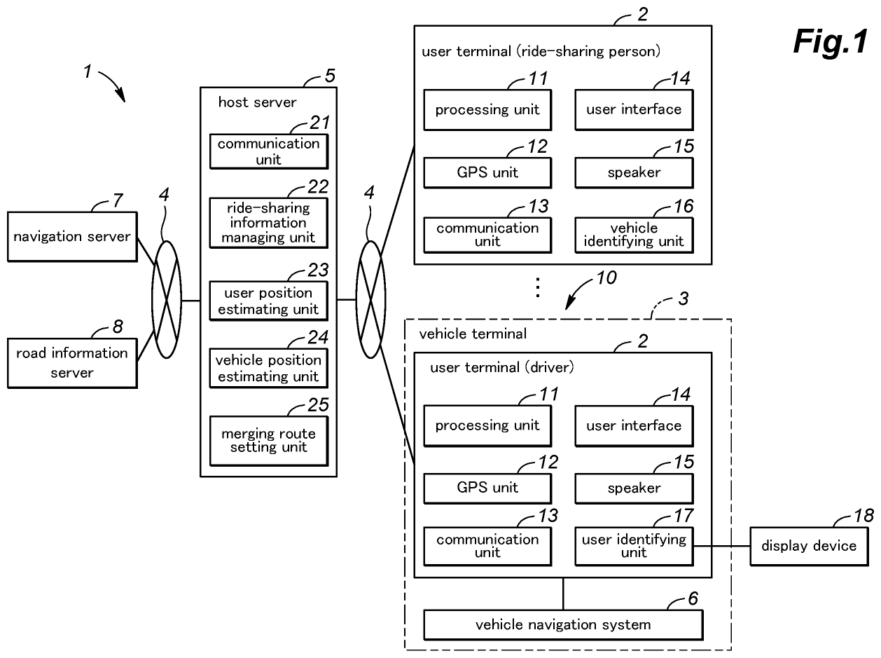

As shown in FIG. 1, the vehicle ride-sharing assist system 1 includes plural wirelessly communicable user terminals 2 (one of the user terminals 2 is shown in FIG. 1), a wirelessly communicable vehicle terminal 3 configured to be mounted on the ride-sharing vehicle 10, and a host server 5 connected to each user terminal 2 and the vehicle terminal 3 via a network 4. Each user terminal 2 is configured to be carried by each user. The vehicle terminal 3 is composed of the user terminal 2 carried by the driver (user) of the ride-sharing vehicle 10 and a vehicle navigation system 6 provided in the ride-sharing vehicle 10. The host server 5 is provided inside the building of the company that manages the vehicle ride-sharing assist system 1, and is connected to a navigation server 7 and a road information server 8 via the network 4. The network 4 is, for example, the Internet.

Each user terminal 2 includes a processing unit 11, a Global Positioning System unit 12 (GPS unit), and a communication unit 13. The processing unit 11 is configured to execute an application. The GPS unit 12 is a position detecting unit configured to receive radio waves from satellites so as to measure a position of the user terminal 2. The communication unit 13 is configured to communicate with the host server 5 via the network 4. Further, each user terminal 2 includes a user interface 14, a speaker 15, and a vehicle identifying unit 16. The user interface 14 is configured to display an input screen and a message and to receive an input operation by the user. The speaker 15 is configured to generate a notification sound and a guidance voice. The vehicle identifying unit 16 is configured to identify the ride-sharing vehicle 10. The user terminal 2 consists of, for example, a smartphone, a tablet PC, a mobile phone, or a PDA. The user terminal 2 is configured to operate as the processing unit 11 executes the application and thus to display the undermentioned various screens on the user interface 14. The vehicle identifying unit 16 is a functional unit configured to perform a function of identifying the ride-sharing vehicle 10 as the processing unit 11 executes the application. The user interface 14 is configured to display a position of the ride-sharing vehicle 10 identified by the vehicle identifying unit 16.

The user terminal 2 that composes the vehicle terminal 3 (namely, the user terminal 2 carried by the driver) includes a user identifying unit 17 instead of the vehicle identifying unit 16. The user identifying unit 17 is configured to identify the user set as the ride-sharing person. The user identifying unit 17 is a functional unit configured to perform a function of identifying the user as the processing unit 11 executes the application. A display device 18 is mounted on the ride-sharing vehicle 10. The display device 18 is configured to display a position of the user identified by the user identifying unit 17 on a windshield. For example, the display device 18 is configured to display the position of the identified user on the windshield by projecting the position of the identified user on the windshield based on the direction of the identified user and the distance to the identified user.

Like the user terminal 2, the vehicle navigation system 6 includes units such as a processing function unit configured to execute an application, a GPS function unit, a communication function unit, a user interface function unit, and a speaker.

The host server 5 includes a communication unit 21 and a ride-sharing information managing unit 22. The communication unit 21 is configured to communicate with each user terminal 2 via the network 4. The ride-sharing information managing unit 22 is configured to set the operation schedule for the ride-sharing vehicle 10 in response to the ride-sharing application from the user and a ride-sharing approval from the driver, and to manage the operation of the ride-sharing vehicle 10. The ride-sharing information managing unit 22 is configured to accept the ride-sharing application from the user, to store application information of the user who desires to perform the ride-sharing, to create plural ride-sharing groups by combining the user who has made the ride-sharing application with the driver, to determine the commuting route (operation route) of each ride-sharing group by using the external navigation server 7, and to set the operation schedule for the commuting route.

The operation schedule set by the ride-sharing information managing unit 22 includes a merging schedule from the departure point to the merging point P and a ride-sharing schedule from the merging point P to the destination. The merging schedule is set based on the departure point and the departure time of each of the ride-sharing vehicle 10 and the user. The merging schedule includes the merging point P and the merging time of the ride-sharing vehicle 10 and the user, the vehicle route Rv of the ride-sharing vehicle 10 to the merging point P and the user route Ry of the user to the merging point P, which are set based on the departure point and the departure time of each of the ride-sharing vehicle 10 and the user.

Further, the host server 5 includes a user position estimating unit 23 configured to estimate the position of the user and a vehicle position estimating unit 24 configured to estimate the position of the ride-sharing vehicle 10. The user position estimating unit 23 is configured to acquire positional information detected by the GPS unit 12 of the user terminal 2 via the network 4 and to estimate the acquired positional information as the position of the user. The vehicle position estimating unit 24 is configured to acquire positional information from the GPS function unit of the vehicle navigation system 6 of the vehicle terminal 3 via the network 4 and to estimate the positional information detected by the vehicle navigation system 6 as the position of the ride-sharing vehicle 10. Alternatively, the vehicle position estimating unit 24 is configured to estimate the positional information of the user terminal 2 carried by the driver as the position of the ride-sharing vehicle 10.

Further, the host server 5 includes a merging route setting unit 25 configured to estimate a scheduled arrival time at the merging point P of each of the ride-sharing vehicle 10 and the user based on estimation results of the user position estimating unit 23 and the vehicle position estimating unit 24 and to set a merging route Rm where the ride-sharing vehicle 10 and the user should merge with each other along the vehicle route Rv or the user route Ry of one of the ride-sharing vehicle 10 and the user. The scheduled arrival time of the one of the ride-sharing vehicle 10 and the user is later than the scheduled arrival time of the other of the ride-sharing vehicle 10 and the user. The merging route Rm set by the merging route setting unit 25 is transmitted to the user terminal 2 and the vehicle terminal 3 by the communication unit 21.

Although not shown, in addition to the above functional units, the host server 5 includes other units such as a user information managing unit configured to manage user information of each registered user, a vehicle information managing unit configured to manage vehicle information of each registered vehicle, and a road information acquiring unit configured to acquire a congestion state of a road by using the external road information server 8. The user information managing unit is configured to store the user information of each user, such as a user number, a user name, an address, a driving skill level, an expiration date of a driver's license, a traffic violation history, violation points of the driver's license, past information as the driver, a vehicle identification number of the provided vehicle (the private vehicle which the user has agreed to use for the ride-sharing) owned by the user, self-reported physical condition, and a ride-sharing history. Further, the user information managing unit is configured to store conditions to be the driver, namely, conditions required to be selected as the driver of the ride-sharing. The vehicle information managing unit is configured to store the vehicle information of each vehicle, such as a vehicle number, a vehicle type, a passenger capacity, fuel efficiency, CO₂ emissions, a due date of a vehicle inspection, a legal inspection history, a legal inspection result, and a ride-sharing utilization history. Further, the vehicle information managing unit is configured to store conditions to be the ride-sharing vehicle 10, namely, conditions required to be selected as the ride-sharing vehicle 10.

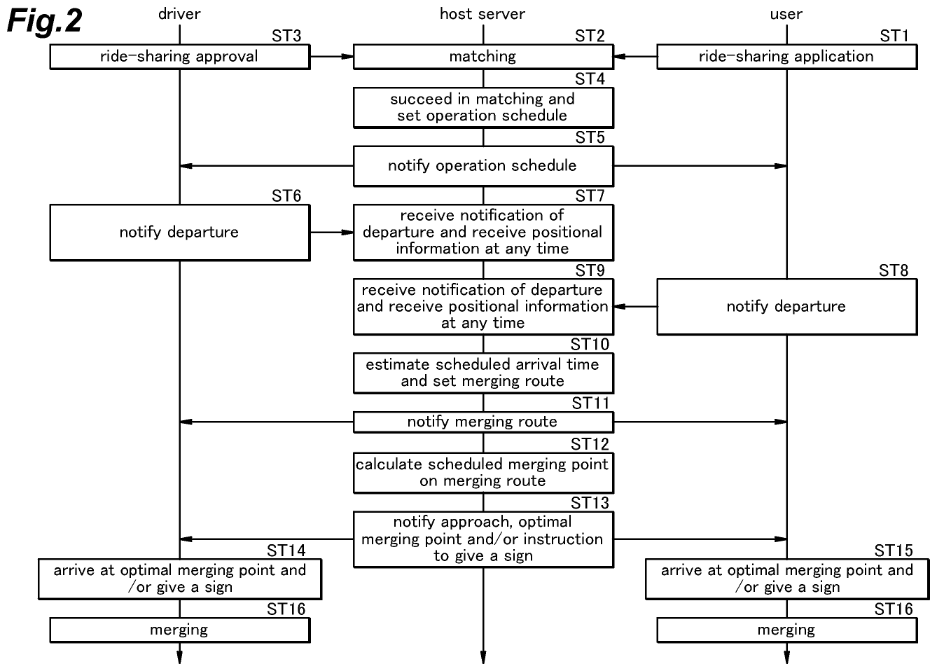

FIG. 2 is a sequence diagram showing a flow of the ride-sharing service according to the present embodiment. As shown in FIG. 2, regarding the vehicle ride-sharing assist system 1, the ride-sharing service is provided by the following transmission/reception of signals and the following processing. First, the ride-sharing application is transmitted from the user terminal 2 of the user to the host server 5 (step ST1). Then, the ride-sharing information managing unit 22 of the host server 5 executes matching processing in response to the received ride-sharing application (step ST2). Then, if the ride-sharing approval is transmitted from the user terminal 2 of the driver to the host server 5 (step ST3), the matching succeeds and thus the ride-sharing information managing unit 22 of the host server 5 sets the operation schedule of the ride-sharing service (step ST4). The operation schedule includes the merging point P, the merging time, and the operation route (the user route Ry and the vehicle route Rv). After the operation schedule is set, the communication unit 21 of the host server 5 notifies the user terminal 2 carried by the driver and the user terminal 2 carried by the user of the operation schedule including the merging point P, the merging time, and the operation route (step ST5).

When a scheduled operation time of the ride-sharing service (the departure time of the ride-sharing vehicle 10) is approaching, the driver notifies the host server 5 of the departure via the communication unit 13 of the vehicle terminal 3 (step ST6), and thus the host server 5 receives the notification of the departure from the driver (step ST7). The notification of the departure of the driver may be given when the driver departs from the driver's home or workplace to the ride-sharing vehicle 10, or may be given when the driver starts moving the ride-sharing vehicle 10 parked at a place remote from the driver's home or workplace. Also, the user notifies the host server 5 of the departure via the communication unit 13 of the user terminal 2 (step ST8), and the host server 5 receives the notification of the departure from the user terminal 2 (step ST9). The notification of the departure of the user may be given when the user departs from the user's home to the merging point P. A signal of the departure may be transmitted earlier from either the user terminal 2 of the driver or the user terminal 2 of the user. For example, in a case where the merging point P is set in a place remote from the user's home, the user may depart earlier than the driver.

On receiving the notification of the departure from the driver and the user, the merging route setting unit 25 of the host server 5 estimates the scheduled arrival time at the merging point P of each of the user and the ride-sharing vehicle 10 based on the positional information of the vehicle terminal 3 estimated by the vehicle position estimating unit 24 and the positional information of the user terminal 2 estimated by the user position estimating unit 23, and sets the merging route Rm along the route (the vehicle route Rv or the user route Ry) of one of the ride-sharing vehicle 10 and the user (step ST10). The scheduled arrival time of the one of the ride-sharing vehicle 10 and the user is later than the scheduled arrival time of the other of the ride-sharing vehicle 10 and the user. The above merging route Rm means not a point set as a merging place (for example, the merging point P) but a line (route) set as a merging place on a road with a certain length. The merging route Rm is set from the merging point P along either the vehicle route Rv or the user route Ry such that the merging route Rm has a prescribed length. The length of the merging route Rm is set according to a difference in the scheduled arrival times at the merging point P. Even if the difference in the scheduled arrival times is the same regarding plural cases, the length of the merging route Rm is generally set longer in a case where the ride-sharing vehicle 10 arrives earlier than the user (namely, in a case where the merging route Rm is set along the user route Ry), compared with a case where the user arrives earlier than the ride-sharing vehicle 10 (namely, a case where the merging route Rm is set along the vehicle route Rv). However, this generalization may not be applied to a case where the estimated speed of the ride-sharing vehicle 10 is low due to traffic congestion.

Next, the communication unit 21 of the host server 5 notifies the driver and the user of the merging route Rm that has been set (step ST11). After that, the merging route setting unit 25 of the host server 5 estimates the scheduled arrival time at the merging route Rm of the ride-sharing vehicle 10 and the user based on the positional information of the vehicle terminal 3 and the positional information of the user terminal 2 of the user, and calculates a scheduled merging point on the merging route Rm (step ST12). When the merging route setting unit 25 detects that the ride-sharing vehicle 10 and the user have approached each other, the communication unit 21 of the host server 5 notifies the driver and the user that the ride-sharing vehicle 10 and the user have approached each other, and notifies the driver and the user of an optimal merging point set by the merging route setting unit 25. Further, the communication unit 21 of the host server 5 notifies the driver and the user of an instruction to give a sign together with or instead of the notification of the optimal merging point (step ST13). The driver receives at least one of the optimal merging point and the instruction to give a sign by using the vehicle terminal 3 (step ST14). Also, the user receives at least one of the optimal merging point and the instruction to give a sign by using the user terminal 2 (step ST15). The driver and the user can merge with each other by arriving at the notified optimal merging point or by giving a sign (step ST16).

As described above, the merging route setting unit 25 of the host server 5 estimates the scheduled arrival time at the merging point P of each of the ride-sharing vehicle 10 and the user based on the estimation results of the user position estimating unit 23 and the vehicle position estimating unit 24, and sets the merging route Rm along the vehicle route Rv or the user route Ry. Then, the communication unit 21 of the host server 5 notifies the vehicle terminal 3 and the user terminal 2 of the merging route Rm. Accordingly, a waiting time can be reduced when the ride-sharing vehicle 10 and the user merge with each other. Further, the merging route setting unit 25 sets the merging route Rm along the vehicle route Rv or the user route Ry of one of the ride-sharing vehicle 10 and the user, and the scheduled arrival time of the one of the ride-sharing vehicle 10 and the user is later than the scheduled arrival time of the other of the ride-sharing vehicle 10 and the user. Accordingly, the time required for merging can be shortened, so that the vehicle and user merging assist system that enables efficient merging can be provided. Further, not a point but the merging route Rm with a certain length is set as a merging place. Accordingly, the ride-sharing vehicles 10 to merge with the users do not concentrate at one point and thus congestion of the ride-sharing vehicles 10 to merge with the users is prevented, which also assists in efficient merging.

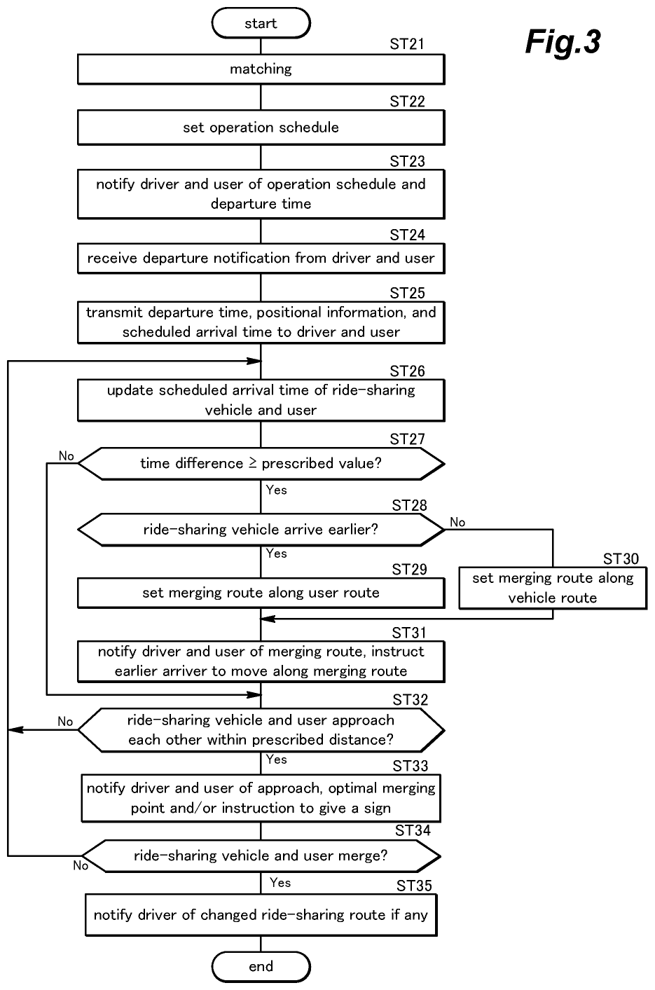

FIG. 3 is a flowchart of ride-sharing service processing executed by the host server 5. This processing partially overlaps with the above processing described with reference to FIG. 2. Accordingly, in the following, detailed descriptions of the overlapping part will be omitted and a flow of the processing will be described mainly. Further, in the following, a setting method of the operation route and the merging route Rm and a changing method of the ride-sharing route Rs will be described with reference to a specific example.

The ride-sharing information managing unit 22 of the host server 5 executes matching processing in response to the ride-sharing application from the user (step ST21), and sets the operation schedule of the ride-sharing service if the matching succeeds. The operation schedule of the ride-sharing service includes the merging point P, the merging time, the vehicle route Rv of the driver to the merging point P, and the user route Ry of the user to the merging point P (step ST22). At this time, the ride-sharing information managing unit 22 also calculates the time when the driver and the user should depart (a rough estimate of the departure time).

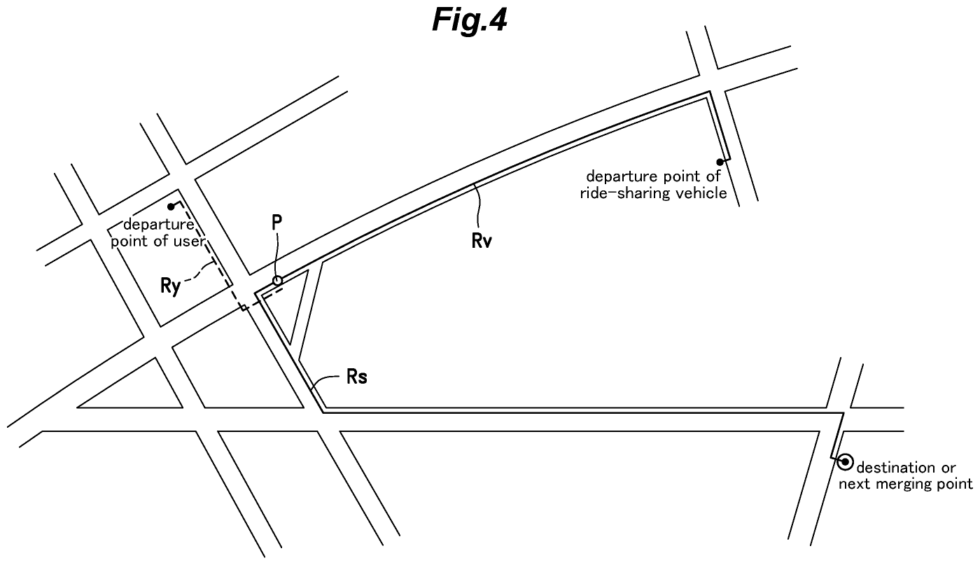

FIG. 4 is a schematic diagram of the operation schedule set in step ST22 of FIG. 3. For example, the operation schedule is set as shown in FIG. 4. In FIG. 4, a route shown by a solid line indicates the vehicle route Rv of the ride-sharing vehicle 10 from the departure point to the merging point P and the ride-sharing route Rs of the ride-sharing vehicle 10 from the merging point P to the destination or the next merging point P. In FIG. 4, a route shown by a dotted line indicates the user route Ry of the user from the departure point to the merging point P.

When setting the operation schedule, the ride-sharing information managing unit 22 of the host server 5 sets the user route Ry on a side of a lane of a road at least in the vicinity of the merging point P, and the lane corresponds to a traveling direction of the ride-sharing vehicle 10. Accordingly, the ride-sharing vehicle 10 and the user moving in the vicinity of the merging point P can easily find each other. Also, after the ride-sharing vehicle 10 and the user find each other, the user can board the ride-sharing vehicle 10 without crossing the road, so that merging can be efficient.

Also, when setting the operation schedule, the ride-sharing information managing unit 22 of the host server 5 sets the merging point P on a road where the ride-sharing vehicle 10 can stop and a sidewalk is provided. Accordingly, the merging point P is set on a road suitable for merging, so that merging can be efficient.

Referring back to FIG. 3, next, the communication unit 21 of the host server 5 notifies the driver and the user of the operation schedule and the rough estimate of the departure time (step ST23). After that, the host server 5 receives the notification of the departure (departure notification) from the driver and the user (step ST24).

When the host server 5 receives the departure notification from the driver and the user, the merging route setting unit 25 of the host server 5 calculates the scheduled arrival time at the merging point P of each of the driver and the user, and the communication unit 21 of the host server 5 transmits the scheduled arrival time to the driver and the user (step ST25).

As described above, the merging route setting unit 25 starts estimating the scheduled arrival time after receiving a vehicle departure signal indicating that the ride-sharing vehicle 10 will depart from the departure point and a user departure signal indicating that the user will depart from the departure point. Accordingly, it is not necessary to estimate the scheduled arrival time before the departure of the ride-sharing vehicle 10 and the user, so that the processing load of the merging route setting unit 25 can be reduced.

Then, the host server 5 updates the scheduled arrival times at the merging point P of the ride-sharing vehicle 10 and the user based on the positional information of the vehicle terminal 3 and the user terminal 2 (step ST26). The scheduled arrival time may be updated at prescribed time intervals or at any time. After updating the scheduled arrival time, the host server 5 determines whether the time difference between the scheduled arrival time of the ride-sharing vehicle 10 and the scheduled arrival time of the user is equal to or more than a prescribed value (step ST27). In a case where the time difference between the scheduled arrival times is equal to or more than the prescribed value (Yes in step ST27), the host server 5 determines whether the ride-sharing vehicle 10 will arrive earlier than the user (whether the scheduled arrival time of the ride-sharing vehicle 10 is earlier than the scheduled arrival time of the user) (step ST28)

In a case where the ride-sharing vehicle 10 will arrive earlier than the user (Yes in step ST28), the host server 5 sets the merging route Rm along the user route Ry (step ST29). On the other hand, in a case where the user will arrive earlier than the ride-sharing vehicle 10 (No in step ST28), the host server 5 sets the merging route Rm along the vehicle route Rv (step ST30).

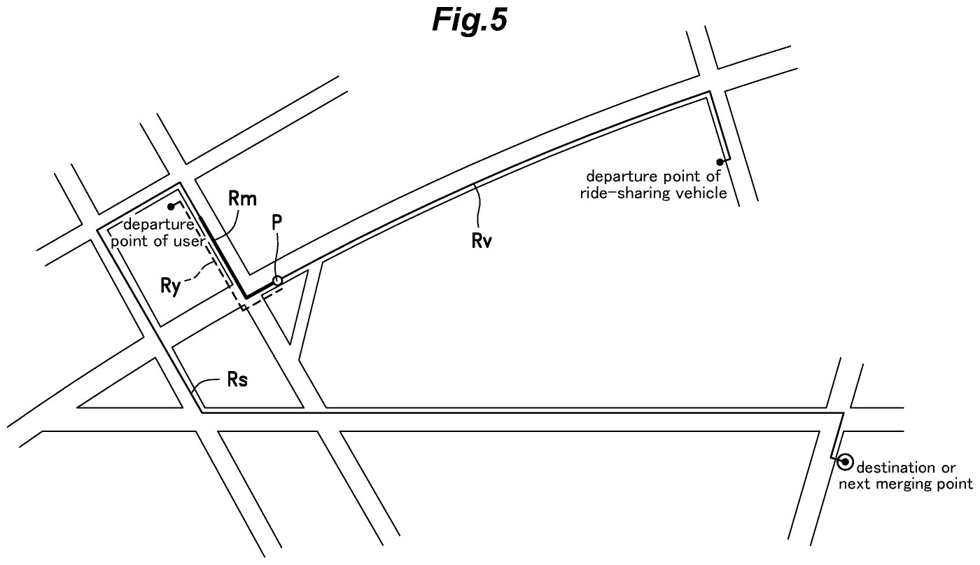

FIG. 5 is a schematic diagram of the operation schedule set in step ST29 of FIG. 3. As shown in FIG. 5, the merging route Rm is set from the merging point P along the user route Ry such that the merging route Rm has a prescribed length. As described above, the length of the merging route Rm is set according to the difference in the scheduled arrival times, the estimated speed of the ride-sharing vehicle 10, and the like. The merging route Rm is set along the user route Ry, and thus the operation route of the ride-sharing vehicle 10 (more specifically, the ride-sharing route Rs of the ride-sharing vehicle 10 from the merging point P to the destination) is changed. On the other hand, the vehicle route Rv of the ride-sharing vehicle 10 is not changed.

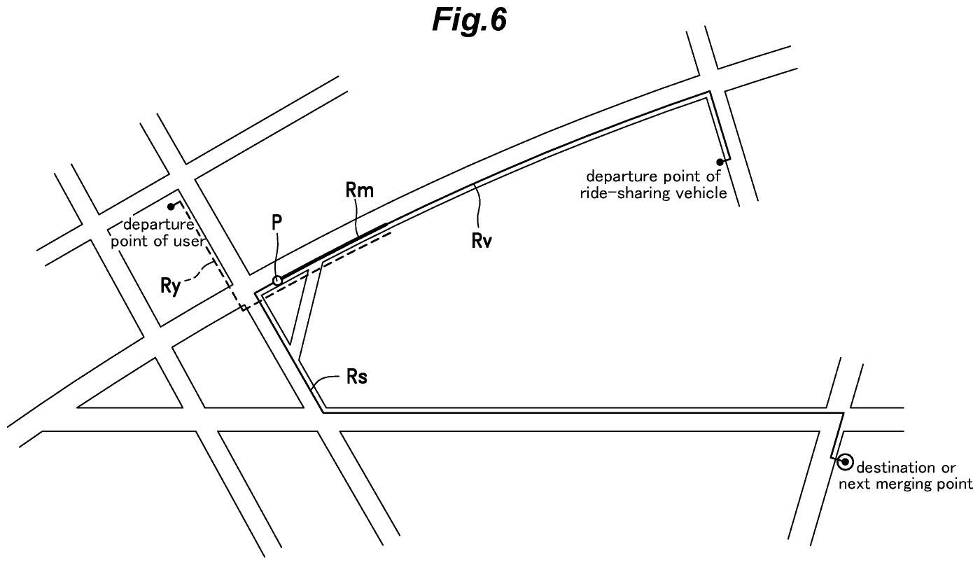

FIG. 6 is a schematic diagram of the operation schedule set in step ST30 of FIG. 3. As shown in FIG. 6, the merging route Rm is set from the merging point P along the vehicle route Rv such that the merging route Rm has a prescribed length. As described above, the length of the merging route Rm is set according to the difference in the scheduled arrival times, the estimated speed of the ride-sharing vehicle 10, and the like. The merging route Rm is set along the vehicle route Rv, and thus the ride-sharing route Rs of the ride-sharing vehicle 10 is not changed. Even though the ride-sharing route Rs of the ride-sharing vehicle 10 is not changed at this time, the operation route may be shortened by changing the ride-sharing route Rs depending on the actual merging point P.

When setting the merging route Rm, the merging route setting unit 25 sets the merging route Rm on a road where the ride-sharing vehicle 10 can stop and a sidewalk is provided. Accordingly, the merging route Rm is set on a road which is suitable for merging and where the ride-sharing vehicle 10 or the user can easily move, so that merging can be efficient.

After setting the merging route Rm in step ST29 or step ST30, the host server 5 notifies the driver and the user of the merging route Rm that has been set, instructs one of the driver and the user who will arrive at the merging point P earlier to move along the merging route Rm (step ST31), and proceeds to the processing in step ST32. In a case where the time difference between the scheduled arrival times is less than the prescribed value (No in step ST27), the host server 5 proceeds to the processing in step ST32 without executing the processing in steps ST28 to ST30.

In step ST32, the host server 5 determines whether the ride-sharing vehicle 10 and the user have approached each other within a prescribed distance. In a case where the ride-sharing vehicle 10 and the user have not approached each other within the prescribed distance (step ST32: No), the host server 5 repeats the processing in and after step ST26. In a case where the ride-sharing vehicle 10 and the user have approached each other within the prescribed distance (step ST32: Yes), the communication unit 21 of the host server 5 notifies the driver and the user that the ride-sharing vehicle 10 and the user have approached each other, and notifies the driver and the user of at least one of the optimal merging point and the instruction to give a sign (step ST33).

As described above, when the ride-sharing vehicle 10 and the user have approached each other, the communication unit 21 of the host server 5 notifies the vehicle terminal 3 and the user terminal 2 that the ride-sharing vehicle 10 and the user have approached each other, so that the ride-sharing vehicle 10 and the user can easily find each other.

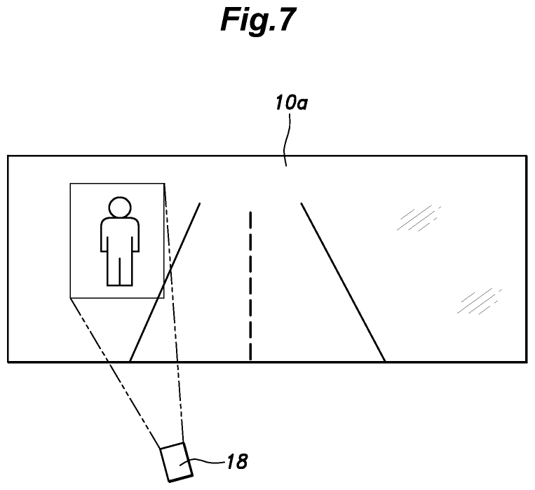

FIG. 7 is a diagram showing a user identifying screen displayed on the ride-sharing vehicle 10. The user identifying unit 17 (see FIG. 1) of the vehicle terminal 3 identifies the position of the user (the user terminal 2) based on the positional information of the user terminal 2 transmitted from the host server 5 or short-distance wireless communication with the user terminal 2, and the display device 18 displays the user. In the example shown in FIG. 7, a frame surrounding an area where the user should be present is projected on the windshield 10a based on the position of the user and the position of the driver's sight-line.

As described above, the ride-sharing vehicle 10 includes the display device 18 configured to display the position of the user on the windshield 10a based on the estimation results of the user position estimating unit 23 and the vehicle position estimating unit 24. Accordingly, the driver of the ride-sharing vehicle 10 can easily find the user, so that the driver and the user can easily merge with each other.

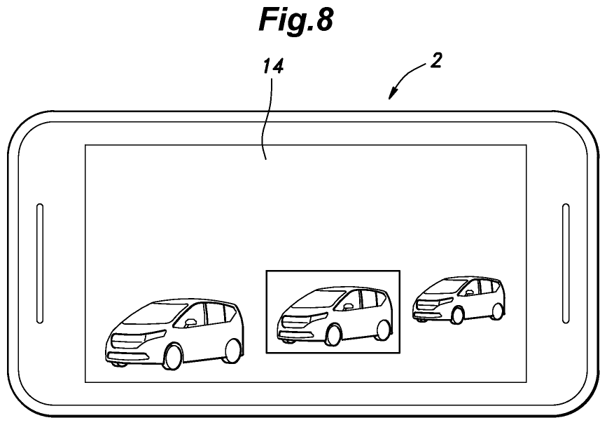

FIG. 8 is a diagram showing a ride-sharing vehicle identifying screen displayed on the user terminal 2. The vehicle identifying unit 16 of the user terminal 2 identifies the position of the ride-sharing vehicle 10 based on the positional information of the ride-sharing vehicle 10 transmitted from the host server 5 or short-distance wireless communication with the vehicle terminal 3. The user interface 14 (display) displays a frame surrounding an area where the ride-sharing vehicle 10 should be present in the surrounding scenery displayed thereon by using the camera function. Accordingly, the user can identify the ride-sharing vehicle 10 to merge with and thus easily merge with the ride-sharing vehicle 10.

As described above, the user terminal 2 includes the vehicle identifying unit 16 configured to identify the ride-sharing vehicle 10 based on the estimation results of the user position estimating unit 23 and the vehicle position estimating unit 24. Accordingly, the user can easily find the ride-sharing vehicle 10, so that the driver and the ride-sharing vehicle 10 can easily merge with each other.

Then, the host server 5 determines whether the ride-sharing vehicle 10 and the user have merged with each other (step ST34). In a case where the ride-sharing vehicle 10 and the user have not merged with each other (step ST34: No), the host server 5 repeats the processing in and after step ST26. In a case where the ride-sharing vehicle 10 and the user have merged with each other (step ST34: Yes), the host server 5 determines whether the ride-sharing route Rs from the actual merging point P to the destination can be changed (whether the ride-sharing route Rs can be shortened). In a case where the ride-sharing route Rs can be changed, the host server 5 changes the ride-sharing route Rs, notifies the driver (namely, the vehicle terminal 3) of the changed ride-sharing route Rs (step ST35), and ends this processing.

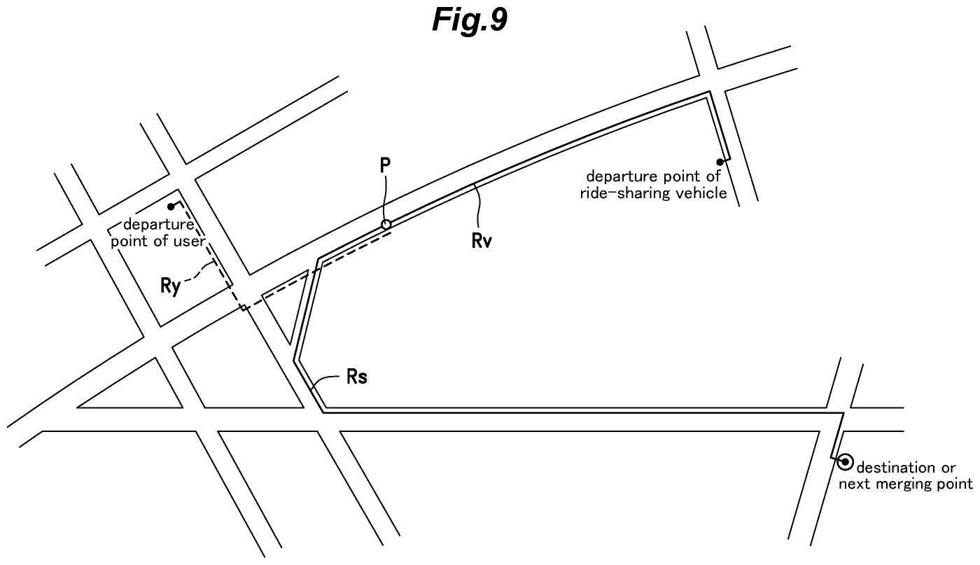

FIG. 9 is a schematic diagram of the changed ride-sharing route Rs set in step ST35 of FIG. 3. In a case where the actual merging point P is present on an upstream side of the initially set merging point P, namely, in a case where the actual merging point P is present on the original vehicle route Rv (see FIG. 4), the operation route may be shortened by changing the ride-sharing route Rs. As shown in FIG. 9, in a case where a road that can shorten the operation route is present between the actual merging point P and the initially set merging point P (see FIG. 4), the ride-sharing information managing unit 22 of the host server 5 changes the ride-sharing route Rs from the actual merging point P to the destination such that the operation route is shortened, and the communication unit 21 of the host server 5 notifies the vehicle terminal 3 of the changed ride-sharing route Rs.

As described above, in the vehicle ride-sharing assist system 1 according to the present embodiment, in a case where it is determined that the user has boarded the ride-sharing vehicle 10 at a place different from the merging point P on the merging route Rm, the ride-sharing information managing unit 22 changes the ride-sharing route Rs and the communication unit 21 notifies the vehicle terminal 3 of the changed ride-sharing route. Accordingly, the ride-sharing route can be shortened, and thus ride-sharing and operation of the vehicle ride-sharing assist system 1 can be efficient.

Concrete embodiments of the present invention have been described in the foregoing, but the present invention should not be limited by the foregoing embodiments and various modifications and alterations are possible. For example, the vehicle and user merging assist system is applied to the vehicle ride-sharing assist system 1 in the above embodiment, but the vehicle and user merging assist system may be applied to a car sharing system. In such a case, a shared vehicle can be delivered efficiently from one user who is using the shared vehicle first to another user who will use the shared vehicle next. Further, the vehicle is driven by the driver in the above embodiment, but the vehicle may be provided with an automatic driving system and the driver may not board the vehicle. Further, the vehicle terminal 3 is composed of the user terminal 2 carried by the driver of the ride-sharing vehicle 10 and the vehicle navigation system 6 provided in the ride-sharing vehicle 10 in the above embodiment, but the vehicle terminal 3 may be composed of either one of the user terminal 2 and the vehicle navigation system 6. Also, a specific configuration and arrangement of each member, each functional unit, quantity, processing steps, and the like can be changed appropriately within the scope of the present invention. Further, not all the components shown in the above embodiment are necessarily indispensable, and these components may be selected appropriately.

### Glossary of Terms

1: vehicle ride-sharing assist system (vehicle and user merging assist system)
2: user terminal
3: vehicle terminal
5: host server
10: ride-sharing vehicle
16: vehicle identifying unit
17: user identifying unit
18: display
21: communication unit (notification unit)
22: ride-sharing information managing unit (merging schedule setting unit, operation schedule setting unit)
23: user position estimating unit (position estimating unit)
24: vehicle position estimating unit (position estimating unit)
25: merging route setting unit
P: merging point
Rm: merging route
Rs: ride-sharing route
Rv: vehicle route
Ry: user route

1. A vehicle and user merging assist system for assisting in merging of a vehicle and a user, comprising:
a vehicle terminal configured to be mounted on the vehicle;
a user terminal configured to be carried by the user; and
a server configured to communicate with the vehicle terminal and the user terminal,
wherein the server includes:
a merging schedule setting unit configured to set a merging schedule based on a departure point of each of the vehicle and the user in response to an application of the user transmitted from the user terminal, the merging schedule including a merging point and a merging time of the vehicle and the user, a vehicle route of the vehicle to the merging point, and a user route of the user to the merging point;
a notification unit configured to notify the vehicle terminal and the user terminal of information about the merging schedule;
a position estimating unit configured to estimate a position of the vehicle and a position of the user; and
a merging route setting unit configured to estimate a scheduled arrival time at the merging point of each of the vehicle and the user based on an estimation result of the position estimating unit and to set a merging route where the vehicle and the user should merge with each other along the vehicle route or the user route of one of the vehicle and the user, the scheduled arrival time of the one of the vehicle and the user being later than the scheduled arrival time of another of the vehicle and the user, and
the notification unit is configured to notify the vehicle terminal and the user terminal of the merging route.

2. The vehicle and user merging assist system according to claim 1,
wherein the merging schedule setting unit is configured to set the user route on a side of a lane of a road at least in a vicinity of the merging point, the lane corresponding to a traveling direction of the vehicle.

3. The vehicle and user merging assist system according to claim 1, wherein the merging route setting unit is configured to start estimating the scheduled arrival time after receiving a vehicle departure signal indicating that the vehicle will depart from the departure point and a user departure signal indicating that the user will depart from the departure point.

4. The vehicle and user merging assist system according to claim 1, wherein when the merging route setting unit detects that the vehicle and the user have approached each other within a prescribed distance based on the estimation result of the position estimating unit, the notification unit notifies the vehicle terminal and the user terminal that the vehicle and the user have approached each other.

5. The vehicle and user merging assist system according to claim 1, wherein the merging schedule setting unit is configured to set the merging point on a road where the vehicle can stop and a sidewalk is provided.

6. The vehicle and user merging assist system according to claim 1, wherein the merging route setting unit is configured to set the merging route on a road where the vehicle can stop and a sidewalk is provided.

7. The vehicle and user merging assist system according to claim 1, further comprising a display device configured to be mounted on the vehicle and to display the position of the user on a windshield based on the estimation result of the position estimating unit.

8. The vehicle and user merging assist system according to claim 1, wherein the user terminal includes a vehicle identifying unit configured to identify the vehicle based on the estimation result of the position estimating unit.

9. A vehicle ride-sharing assist system comprising the vehicle and user merging assist system according to claim 1 and configured to provide plural users with ride-sharing of a ride-sharing vehicle,
wherein the server includes an operation schedule setting unit configured to set an operation schedule based on a departure point and a departure time of each of the ride-sharing vehicle and the users in response to a ride-sharing application of each user transmitted from the user terminal, the operation schedule including the merging schedule and a ride-sharing schedule that includes a ride-sharing route from the merging point to a destination, and
in a case where it is determined that the user has boarded the ride-sharing vehicle at a place different from the merging point based on the estimation result of the position estimating unit, the operation schedule setting unit changes the ride-sharing route and the notification unit notifies the vehicle terminal of the changed ride-sharing route.
